(19) United States
(12) Patent Application Publication
(10) Pub. No.: US 2010/0125462 A1
(43) Pub. Date: May 20, 2010

(54) System and method for cost-benefit analysis for treatment of cancer

(75) Inventor: Adeeti Aggarwal, Saratoga, CA (US)

Correspondence Address: WILLIAM L BOTJER, P O BOX 478, CENTER MORICHES, NY, 11934, US

(73) Assignee: ADEETI AGGARWAL, Saratoga, CA (US)

(21) Appl. No.: 12/313,407

(22) Filed: Nov. 20, 2008

(51) Int. Cl. G06Q 50/00

(52) U.S. Cl. 705/3; 705/2

(57) ABSTRACT

A system and method for providing cost-benefit analysis for treatment of a chronic disease such as cancer. The system enables a user to provide input parameters related to a patient, and performs statistical and computational analysis of case histories of other patients and retrospective data related to one or more disease treatment protocols to generate a set of output parameters (potential outcome of the treatment protocols) along with their statistical significance and probability. In addition, the system estimates the cost associated with the treatment protocols using cost related information available for tests, procedures, surgeries, etc., to be performed in a treatment protocol. The average cost and the set of output parameters are displayed to the user which helps in performing the cost-benefit analysis.

The present invention relates to the field of health-care management systems. More particularly, the present invention relates to a system and method for performing a real time cost-benefit analysis for treatment of chronic diseases such as cancer.

During the last few decades, there has been a substantial growth in the heath-care industry. This growth has been primarily focused on development of new techniques, drugs, etc. for treatment of chronic disorders such as cancer, diabetes, hypertension, and HIV-AIDS. Though many advanced techniques have resulted in increased life expectancy, there has also been a substantial increase in treatment costs. Due to the availability of different techniques and treatment protocols, patients often face the dilemma of selecting a particular treatment regimen or protocol without understanding its cost or other implications. Further, there is a conflict of interest between patients, doctors and hospitals, and insurance companies (including government insurance companies such as Medicare or Medicaid in the United States) because these stakeholders analyze the cost and benefits of procedures and treatments from very different perspectives. These objectives usually relate to the trade-off between the benefits (including clinical efficacy, safety concerns, quality of life, and overall survival) and costs (of various tests, imaging procedures, medical consultation, checkups, and the treatment itself). For example, an oncologist may like to follow a wait and see approach to a new therapy that is unfamiliar. On the other hand, patients are usually concerned in prolonging their lives and ensuring a higher quality of life. Accordingly, while calculating the “real value” of a cancer therapy, the cost-benefit analysis that patients may perform can be quite different than that performed by their oncologists.

Some research has been conducted in performing cost-benefit analysis for a few cancer drugs (such as Tamoxifin produced by Astra Zeneca). However, such analysis is quite rudimentary since it does not include other important parameters (e.g., costs of imaging and lab tests) and it cannot be performed in real time. In fact, there seems to be no known cost benefit analysis for performing lumpectomy on a breast cancer patient (where a portion of the breast is removed) versus mastectomy (where the entire breast is removed). Further, the analysis does not consider varied set of objectives of different stakeholders. In addition, such analyses are not robust to include new and enhanced treatment regimens and protocols, technologies, etc., as and when they are developed. Finally, because of the number of variables that influence such an analysis, it is very hard—if not impossible—for a human to perform this analysis (especially in real time).

In light of the forgoing, there is a need for a system and method that can perform a cost-benefit analysis for an end-to-end treatment (of a disease), which can be used by various stakeholders in an effective and efficient manner. This system should also be robust to include new and enhanced treatment protocols and should be easy to integrate with Electronic Medical Record Systems and Electronic Medical Data.

### SUMMARY OF THE INVENTION

An object of the present invention is to perform a cost-benefit analysis for a treatment of a disease such as cancer.

Another objective of the present invention is to enable different stakeholders of the health-care system to perform the cost-benefit analysis in an efficient and effective manner.

Still another object of the invention is to perform a cost-benefit analysis for the treatment of the disease on a real-time basis.

Yet another object of the invention is to provide an effective mechanism to include enhanced and new treatment protocols into such a cost-benefit analysis.

To achieve the objects mentioned above, the present invention provides a system and method which can be implemented with a programmable computer that performs a cost-benefit analysis in real-time for any well-defined medical treatment protocol. Examples of medical treatment protocols may include those for various types of cancer, diabetes, hypertension, HIV-AIDS, and other chronic diseases. A treatment protocol may include medications, lab tests, procedures, consultations, hospitalization, supportive care, and other therapies.

The system includes a graphical user interface (GUI), an analytics engine, and a cost estimation engine. A user of the system interacts with the system using the graphical user interface (GUI). The user provides input parameters (related to a patient) such as patient history (e.g., age, gender, family history, grade of tumor, size of tumor, ethnicity etc.), current state of the patient, treatment administered so far, and the like. The analytics engine performs statistical and computational analysis on the basis of the input parameters to generate a set of potential output parameters. The output parameters represent the potential outcome of a treatment protocol along with the probability (or statistical significance) of the outcome. For example, a potential outcome can be 55% likelihood of the cancer patient being alive for 5 years or more. Other output parameters may include overall survival after a specified number of years, disease-free survival for a specified number of years, progression-free survival for a specified number of years, tumor response rate, time to progression of symptoms, and quality of life.

The analysis also takes into account information related to a “close cohort” corresponding to a selected treatment protocol. A close cohort represents a group of patients that have been subjected to a treatment protocol substantially similar to the selected treatment protocol and that have substantially similar input and output parameters. For example, if a similar treatment protocol is used, and if the case histories of male Caucasian patients with colon cancer who are between 40 and 50 years old have the same survival rates and the same tumor response rate as those of male Hispanic patients (with colon cancer) who are between 50 and 60 years old, then these two groups of patients can be included as part of the same close cohort. (In contrast, a “near identical” cohort is a group of patients that have almost identical input parameters and have gone through almost identical treatments.)

The analytics engine uses a state-transition graph to represent the current state of the patient. Furthermore, the user views this state-transition graph through the GUI. Each vertex of the state-transition graph represents the state of the patient at each stage of the treatment protocol. Hence, by moving from one vertex to another, the user can view the entire state-transition graph for a particular disease (and the treatment protocols that are included in the system for this disease).

For the close cohort to which the current patient belongs and the different treatment protocols as well as their associated costs (and potential outcomes), the cost estimation engine calculates the average, amortized cost of the treatment protocol including those for tests, consultations, hospitalization, drugs, surgeries, supportive care, and other procedures. The output parameters and the corresponding costs are displayed to the user through the GUI. Accordingly, the user may select the “best” suitable treatment protocol or may define his/her protocol (if required) as per his/her criterion.

This system also includes a plurality of databases to store different treatment protocols that are available for the treatment of a disease, case histories of patients, ongoing and past clinical research, and other market research information. In addition, the system also includes a plurality of databases that store cost related information for different treatment protocols (including costs for tests, consultations, hospitalization, drugs, surgeries, supportive care, and other procedures).

In addition, the system allows the user at any stage of the treatment regimen to provide details, if any, that are related to complications or unexpected events.

This system for performing the cost-benefit analysis for a treatment of a disease has number of advantages. The system can be used by all the stakeholders (patients, doctors, insurance companies, and hospitals) and can provide real-time output corresponding to the respective output parameters. Further, the system is robust enough to incorporate enhanced and new treatment protocols (as a part of its analysis). In addition, the system can be easily integrated with various Electronic Medical Record Systems and Electronic Medical Databases.

### BRIEF DESCRIPTION OF THE DRAWINGS

The preferred embodiments of the invention will hereinafter be described in conjunction with the appended drawings provided to illustrate and not to limit the invention, wherein like designations denote like elements, and in which:

FIG. 1 is a block diagram of a system for performing cost-benefit analysis for a treatment of a disease in accordance with an embodiment of the invention;

FIG. 2 is a block diagram of an analytics engine in accordance with FIG. 1;

FIG. 3 is a block diagram illustrating a state transition graph indicating the current position and future outcome of the treatment protocol for the disease in accordance with an embodiment of the invention;

FIG. 4 is a flowchart of a method for providing cost-benefit analysis for a treatment of a disease in accordance with an embodiment of the invention; and

FIG. 5a and FIG. 5b illustrate an exemplary state-transition graph for treatment of breast cancer in accordance with an embodiment of the invention.

### DESCRIPTION OF VARIOUS EMBODIMENTS

It is to be understood that the invention is not limited in its application to the details of construction and the arrangement of components set forth in the following description or illustrated in the drawings. The invention is capable of other embodiments and of being practiced or of being carried out in various ways. Also, it is to be understood that the phraseology and terminology used herein is for the purpose of description and should not be regarded as limiting. For example, the use of “including,” or “comprising,” and variations thereof herein is meant to encompass the items listed thereafter and equivalents thereof as well as additional items. Further, the terms ‘treatment regimen’, ‘treatment course’, and ‘treatment protocol’ have been used interchangeably. In addition, the terms ‘disease’ and ‘disorder’ have also been used interchangeably.

Various embodiments of the present invention provide a system for providing a cost-benefit analysis for treatment of a chronic disease such as cancer, HIV-AIDS, and diabetes. The system performs statistical and computational analysis based on information related to the treatment protocol, and computes a close cohort corresponding to a given patient and the treatment protocol (for this patient). Using the inputs provided by a user, the system determines potential outcomes at different stages of the treatment. Further, the cost associated at each stage is determined. Accordingly, different treatment protocols for the treatment of the disease are displayed to the user along with potential outcomes at each stage and the associated costs. This helps the user to select a treatment protocol as per his/her objectives and as per his/her patient's objectives.

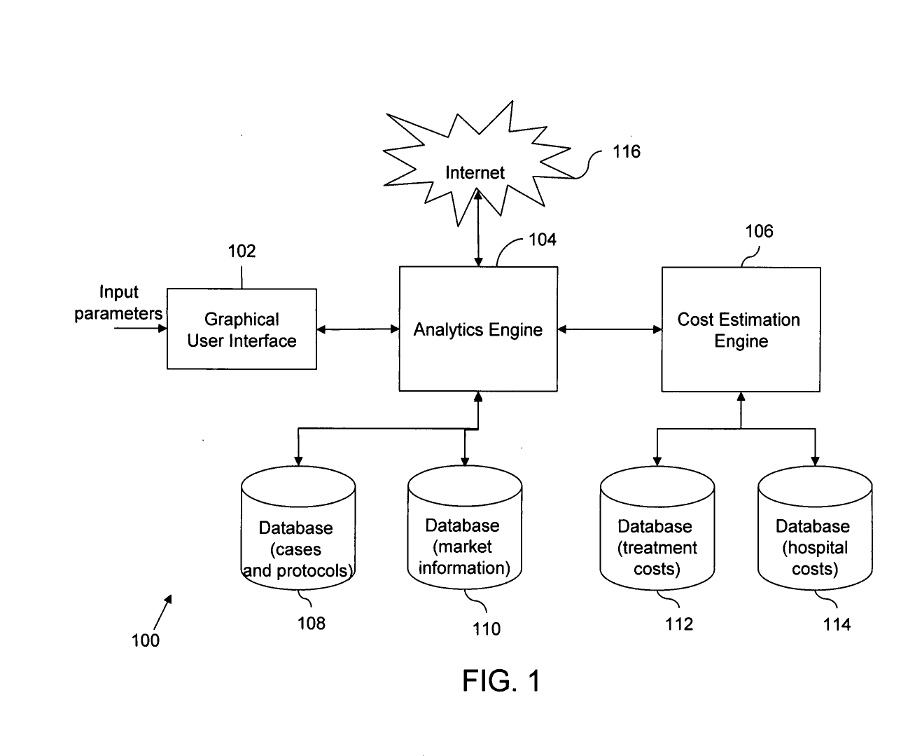

FIG. 1 is a block diagram of a system 100 for performing a cost-benefit analysis for treatment of a disease in accordance with various embodiments of the invention. System 100 includes a graphical user interface (GUI) 102, an analytics engine 104 and a cost estimation engine 106. System 100 also includes a plurality of databases such as database 108, database 110, database 112, and database 114. System 100 is connected to an outside network via Internet 116.

GUI 102 enables a user to interact with System 100. The user may provide input parameters related to historical information of a patient and one or more treatment protocols that may be used for the treatment of the patient. Further, output of the analysis performed by system 100 is displayed to the user via GUI 102. Analytics engine 104 performs statistical and computational analysis based on the input parameters and generates (as well as regularly updates) a state-transition graph representing the different stages of different treatment protocols along with potential outcomes. The statistical and computational analysis includes computing a close cohort for the patient, and based on this close cohort, analytics engine 104 estimates the likelihood of various output parameters (i.e., potential outcomes) and the statistical significance related to these outcomes. The close cohort is computed by using the information related to case histories of patients, clinical research information, market research information, and related information stored in databases 108 and 110. Depending upon the treatment protocol that is selected by the user, cost estimation engine 106 computes the average cost for the treatment by computing the corresponding costs for patients in the close cohort and provides this as the expected cost of the treatment for the patient for a specified number of years. In addition, cost estimation engine 106 also computes the cost that has been incurred till the current time. The expected cost and the potential outcomes corresponding to different treatment protocols are displayed to the user along with the state-transition graph via GUI 102.

The output parameters may include, for example, overall survival for a pre-defined number of years, disease free survival for a pre-defined number of years, tumor response rate, time to progression of symptoms, and quality of life after the treatment. These parameters are explained in the following paragraph.

The overall survival after a pre-defined number of years represents the likelihood of the patient surviving for at least the pre-defined number of years after the treatment versus the likelihood of death within the pre-defined number of years because of the disease or otherwise. The disease free survival for the pre-defined number of years represents the likelihood of the patient surviving without a relapse of the disease for at least the pre-defined number of years after the treatment has been given (i.e., after time t). Tumor response rate represents the likelihood of the patient's tumor responding to a given treatment, therapy or procedure within a defined time period. This defined time period may be different for different types of diseases, and may also be different for different therapies or treatments for the same disease such as cancer. Time to progression of symptoms is related to two other output parameters, progression-free survival and disease-free survival, and is quantified as a function of these parameters. However, by providing an appropriate function, the systems administrator may also define this parameter differently (if the system administrator selects to do so). Quality of life (in the long term, i.e., after the treatment) is a subjective parameter but is usually defined as a function that is based upon pain, fatigue, and the performance status of the patient after the treatment.

Similarly, input parameters may include, for example, age of the patient, sex of the patient, ethnicity, type of the disease, stage of the disease, case history, treatments administered, family history, the region where the patient resides, and the like.

Database 108 and Database 110 store and maintain information related to patient histories (i.e., case histories), treatment protocols (including ones being used, experimental ones, and those undergoing clinical trials) for different diseases, and potential market research information. Analytics engine 104 uses this information for computing the close cohort. The information related to the different protocols can be obtained from information sources such as the United States National Comprehensive Cancer Network. Further, the patient histories for a particular disease can be obtained from sources such as the United States National Cancer Institute. Similarly, databases 112 and 114 store and maintain cost data with respect to costs for each treatment, procedure, lab test, pathology test, diagnostics tests, hospital costs, consultation, checkup, and the like. Such costs may include a sub-database of costs charged upon by a particular hospital or a doctor and/or may have a separate sub-database of costs that a particular insurance company would pay. Databases 108, 110, 112 and 114 may be relational databases or non-relational databases. In an embodiment of the invention, databases 108, 110, 112 and 114 are Microsoft's SQL databases. In another embodiment of the invention databases 108, 110, 112 and 114 are MS Access databases or any other type of relational or non-relational databases.

In various embodiments of the invention, the disease may include any disease that has a well-defined treatment regimen or protocol. Examples of the disease may include various kinds of cancer or chronic disorders such as diabetes, HIV-AIDS, chronic obstructive pulmonary diseases, hypertension, congestive heart failure and coronary artery disease, arthritis, and surgical procedures such as organ transplants and the like. In an embodiment of the invention, system 100 is designed for cancer treatment.

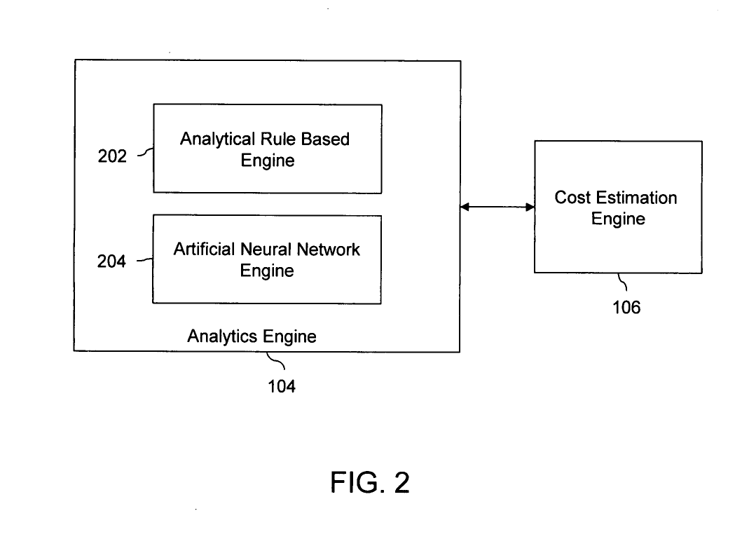

Analytics engine 104 performs the analysis by using classical statistical techniques and by using artificial neural networks. An external system administrator manages analytics engine 104. Managing may the analytics engine may include addition, modification, and deletion of rules associated with processing of information stored in databases 108 and 110. Similarly, cost estimation engine 106 is a cost computation engine that is usually managed by an external system administrator. In various embodiments of the invention, analytics engine 104 and cost estimation engine 106 may be implemented as software module, hardware module, an embedded system, a firmware, and/or a combination there of. The functionalities of analytics engine 104 and cost estimation engine 106 are explained in detail in conjunction with FIG. 2.

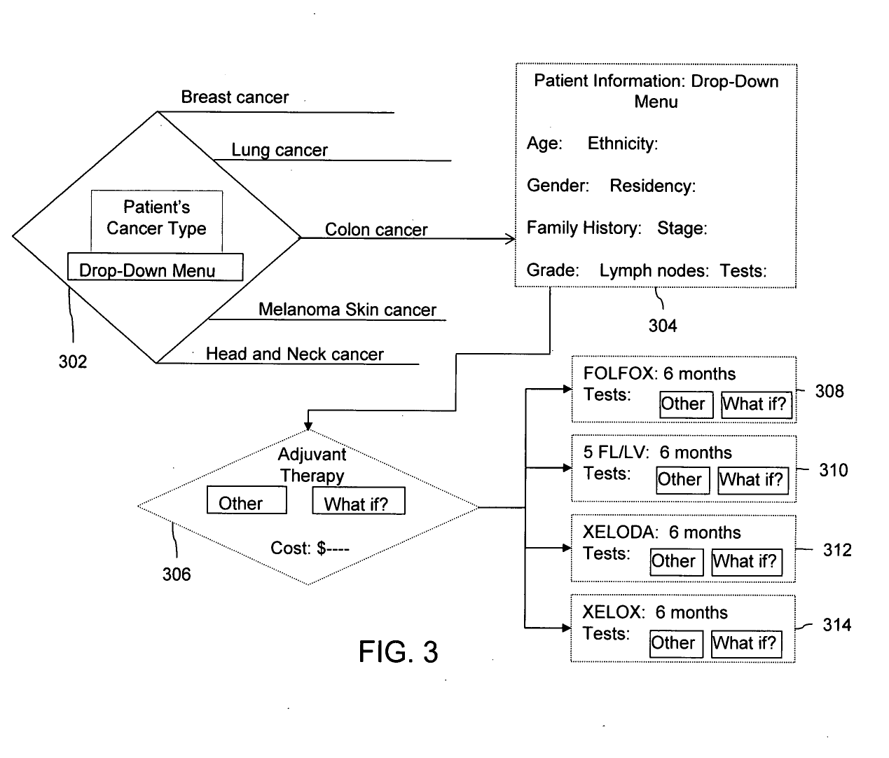

FIG. 2 is a block diagram representing analytics engine 104 and cost estimation engine 106 in accordance with an embodiment of the invention. Analytics engine 104 includes an analytical rule based engine (ARBE) 202 and an artificial neural network engine (ANNE) 204. ARBE 202 and ANNE 204 interact with databases 108 and 110. ARBE 202 and ANNE 204 compute the close cohort, perform the statistical and computational analysis, and also generate the underlying state-transition graph. The state-transition graph has vertices and directed edges. Herein, each vertex indicates a state of the patient at a particular stage of the treatment protocol, probability of potential outcomes at each stage with statistical significance, and amortized costs for performing different procedures and tests (as well as providing drugs) for a specified number of years (as per the treatment protocol). The directed edges originating from a vertex indicate different options that are available at a particular stage of the treatment protocol. An exemplary state-transition graph for treatment of cancer and the user interaction with system 100 is explained in conjunction with FIG. 3.

ARBE 202 receives input parameters related to the patient such as personal details, case history, and treatment protocols that have been administered so far. ARBE 202 is a statistical engine and based on the input parameters, it computes a close cohort for the patient. ARBE 202 also computes the likelihood of various output parameters at the current time (potential outcome) as well as the statistical significance of each output parameter for a selected treatment protocol by using the close cohort information (that it has generated) and external market research information (that is available in one of the databases 108 or 110). The statistical significance includes confidence level and margin of error. For example, a typical output of ARBE 202 may mention that there is a 55% likelihood of a cancer colon patient being alive for 5 years or more, 25% likelihood of the patient dying because of cancer, and 15% likelihood of the patient dying because of other causes; and the confidence level related to this analysis is 95% and the margin of error is ±4%.

For achieving reasonable statistical significance, in various embodiments of the invention, the size of a cohort has been taken as 50 patients. However, obtaining a cohort with “near identical” case histories may not be always possible because there may not exist case histories of 50 patients that have nearly identical input parameters and that have been treated with nearly identical treatment protocols. Hence, in such cases, ARBE 202 computes a close cohort (rather than relying on an a “near identical cohort”). A close cohort is a group of near identical cohorts where the patients in the group have similar but not necessarily identical input parameters, similar treatment protocols, and similar output parameters. The operations of ARBE 202 and ANNE 204 are explained using the following example.

In this example, the user of system 100 provides three input parameters such as age of the patient, grade of the tumor, and the number of affected lymph nodes with respect to that cancer. The age of the patient is partitioned into deciles (one for each decade), the grade of the tumor may take up to 5 values, and the number of affected lymph nodes may take up to 4 values (such as no lymph nodes, 1-3 nodes affected, 4-9 nodes affected, and 10 or more nodes affected). In this example, a patient may belong to any 10*5*4 cubes of the 3-dimensional matrix. Accordingly, each cube represents a “nearly identical cohort” (as long as all the patients corresponding to that cube have been treated with identical or nearly identical treatment protocols). However, it is quite possible that the underlying databases may not have enough patient case histories so that each cube has at least 50 case histories. In such a case, performing statistical analysis on the patient histories corresponding to this cube (and the corresponding “near identical cohort”) may result in fairly low statistical significance. Hence, ARBE 202 creates close cohorts by combining “near identical cohorts.” For example, suppose that the patients' case histories available in databases 108 and 110 (or in the available medical literature) show that patients with ages in the first four deciles have similar output parameters, patients with ages in the next three deciles have similar output parameters, and patients in the last three deciles have similar output parameters then the 10*5*4 cube can be partitioned into three sub-matrices, each of size 5*4. Accordingly, a patient may now belong to 5*4*3=60 sub-cubes where each sub-cube represents a close cohort. Now, as long as each close cohort has a statistically significant number of patient histories (which is usually taken as 50) related to the disease, ARBE 204 uses classical statistical techniques to compute the probabilities of occurrence related to each output parameter. Some classical statistical techniques, for example, are regression and logit. For computing these probabilities, ARBE 204 may also use standard statistical tools (that are widely available in the market) such as SPSS and SAS or the systems administrator may develop his/her own statistical tools.

In various embodiments of the invention, different logical rules (i.e., different sets of rules) can be used to create such close cohorts. For example, it is possible for ARBE 204 to create a close cohort by taking non-adjacent rows of a given multi-dimensional matrix. For example, in the three dimensional matrix described in the above, if all patients that are less than 50 years old and with grades 1, 3 and 5 cancer behave similarly with respect to outcomes (i.e., have similar output parameters for similar treatment regimens), and patients that are less than 50 years and have cancer grades 2 and 4 behave similarly, then the matrix 10*5*4 can be partitioned into sub-matrices 5*5*4 (i.e., 100 sub-cubes for patients that are 50 years or older, each sub-cube representing a separate close cohort), 1*5*4 (i.e., 20 sub-cubes for patients that are less than 50 years of age and have cancer grades 1, 3 and 5, which constitute one close cohort), and 1*5*4 (i.e., 20 sub-cubes for patients that are less than 50 years of age and have cancer grades 2 and 4, which constitute another close cohort).

In an embodiment of the invention, the system administrator defines close cohorts for the available case histories of patients in databases 108 and 110. In another embodiment of the invention, ARBE 202 determines the close cohorts by statistically comparing the input and output parameters of—as well as the treatments provided to—two or more identical cohorts.

In one embodiment of the invention, if a statistically significant number (about 50) of patient histories in a closed cohort are not available then ARBE 202 either limits the number of values that different input parameters can take or eliminates one or more variables. However, in several embodiments of the invention, it is the system administrator who controls the functioning of ARBE 202 and who defines the rules.

The accuracy of prediction by ARBE 202 depends on finding a suitable close cohort. Indeed, at times the patient histories in a close cohort may not be that close and hence doing a statistical analysis (e.g., computing the average survival time) may not yield accurate results. For example, there may be a “near identical cohort” of patient histories of 35 colon cancer patients who are all male, Caucasian, between the age group 40 to 50 years old, and have grade 11 tumor, and that have similar output characteristics when treated with the same treatment protocol. Since this near identical cohort has only 35 case histories, the statistical significance of the output parameters may be low. Similarly, there may be another “identical cohort” of patient histories of 20 colon cancer patients who are all male, Hispanic, between age group 40 to 50 years old, and have grade 11 tumor and similar output characteristics when treated with the same treatment protocol. However, suppose the output characteristics of these two identical cohorts are substantially different. Since each identical cohort is unable to provide the output parameters with reasonable statistical difference, either the systems administrator combines these two cohorts together to make a “close cohort” or ARBE 202 generates a close cohort during the analysis and computation. In such a case, the output parameters associated with the close cohort are likely to be erroneous (because the outcomes related to the two near identical cohorts is substantially different).

In such cases, artificial neural network engine (ANNE) 204 is used as an alternate and an embellishment means for computing the output variables for the close cohort that was determined earlier. Given below are the modifications and alterations made to the standard neural network algorithms so that they can improve the accuracy of the output variables of a given close cohort.

In an embodiment of the invention, ANNE 204 includes six individual sub-engines, one for each output parameter. Each sub-engine of ANNE 204 may have several layers of interconnected vertices. In this embodiment, for simplicity, ANNE 204 has three interconnected layer of vertices—input vertex layer, hidden vertex layer, and the output vertex. The first layer consists of all input variables (and hence there are between 50 to 75 vertices in the first layer) for a particular cancer category, which take between 3 and 8 values (except for a few variables like age of the patient or where the patient resides, which can take up to 100 or so distinct values but can be reduced to 10 values or even lower depending upon the rules and regulations set by the systems administrator). The number of hidden vertices is usually taken to be approximately one tenth the number of input vertices; these sum the inputs and by using a transfer function (which is usually a sigmoid function), provide their output information to the output vertex. The sets of equations given below provide the standard mathematical representation for one sub-engine of ANNE:

hⱼ=fⱼ(w_{1,j}x₁+w_{2,j}x₂+ . . . +w_{m,j}xₘ) (1)

O=g(w₁h₁+w₂h₂+ . . . +wⱼhⱼ) (2)

In the first equation, hⱼ represents the output from the j-th hidden vertex, fⱼ is a non-linear transfer function for the j-th vertex, and w_{i,j} is the weight related to (or predictor from) input variable xᵢ to the j-th hidden vertex. Similarly, in the second equation, O represents the output variable that is being computed by this sub-engine of ANNE 204, g is a non-linear transfer function for the output vertex, and wⱼ is the weight related to (or predicted from) the hidden variable hⱼ to the output vertex. Back-propagation training consists of “fitting” the weights given in the above equation by using a criterion such as least squared error. The difference between the predicted outcome from a sub-engine of ANNE 204 and the actual outcome is propagated back from the output to the connection weights in order to adjust the weights in the direction of minimum error. The sub-engine of ANNE 204 receives its training and stop-training sets from each of the close cohorts that are produced by ARBE 202 for the given output variable. Hence, by working on each close cohort separately, the sub-engine of ANNE 204 is able to predict the outcome much better especially when the close cohort contains patient histories that are not that close (with respect to predicting outcomes).

Once ARBE 202 and ANNE 204 have computed the close cohort and the probability of occurrence for the output variable (for the patient who is undergoing treatment), this probability (or rather probabilities) along with the confidence level and the margin of error is transmitted to analytics engine 104, which in turn relays this information to GUI 102 and to cost estimation engine 106.

Accordingly, cost estimation engine 106 obtains the close cohort information and the corresponding information related to lab tests, imaging tests, and procedures that were administered to the patients in the close cohort. Next, based on the cost-codes associated with each of the lab tests, imaging tests, etc., cost estimation engine 106 obtains the cost data from databases 112 and 114 and accordingly computes the average cost for the entire treatment for the current patient for a pre-specified number of years.

In various embodiments of the invention, analytics engine 104 represents different stages of the treatment protocols in a state-transition graph. Paths originating from each vertex of the state-transition graph represent different options or treatments that are available at that stage. Further, each vertex represents a state of the patient at that particular point of time (during the treatment). Details of the state-transition graph and its display to the user are explained in detail in conjunction with FIG. 3.

FIG. 3 is a block diagram of a state-transition graph displayed to the user of system 100 in accordance with an embodiment of the invention. Herein, the state-transition graph is explained for a patient diagnosed with colon cancer and the potential set of treatment protocols or procedures that may be available for colon cancer.

FIG. 3 shows the state-transition graph having three vertices: vertex 302, vertex 304, and vertex 306. Vertex 302 shows a drop down menu indicating different types of cancer. Vertex 304 provides deterministic input parameters for the patient (that the user needs to fill in) and vertex 306 provides different options related to adjuvant treatment that may be prescribed to the patient. These different options are represented as vertices 308, 310, 312, and 314. The vertices also display the associated cost and “buttons” that represent other scenarios such as ‘what if’ and ‘other’. These functionalities are explained in detail in subsequent paragraphs.

As described earlier, each vertex represents the state of the patient and the treatment protocol at a particular instance of time. For example, vertex 302 represents the state of the patient at the current time ‘t’ and vertex 306 represents the state at time ‘t+1’ along with the patient information and the details related to the selected treatment protocol that a user may perform between time t and time t+1. The connecting arc or arcs originating from one vertex to another vertex or vertices represent the alternatives that are available to the user at that instance of time. For example, for a breast cancer patient, the user may remove the cancer tumor by either performing mastectomy (i.e., complete removal of breast) or lumpectomy (i.e., a removal of only the tumor in the breast). If there is only one arc originating from a vertex then it is referred to as a rectangular vertex. Similarly, if there are more than one paths or arcs originating from a vertex then it is referred to as a diamond vertex. Further, the arc originating from a rectangular vertex is referred to as an execution arc and the arc originating from a diamond vertex are referred to as choice arc. Accordingly, vertex 302 and vertex 306 are diamond vertices, whereas vertex 304, vertex 308, vertex 310, vertex 312 and vertex 314 are all rectangular vertices.

In various embodiments of the invention, initially at time t, only vertex 302 is displayed to the user, and it provides a drop down menu showing different types of cancer. The user may select the relevant cancer that the patient has been diagnosed with. Herein, the user selects colon cancer. Upon selection of colon cancer, the choice arc corresponding to colon cancer is activated and the potential set of procedures or treatment protocols corresponding to this arc are shown to the user. The user selects the treatment protocol that may be provided to the patient. At time t+1, rectangular vertex 304 is activated and the user provides input parameters related to the patient. The input parameters include age of the patient, gender, ethnicity, stage of the cancer, family history, grade of the cancer, affected lymph nodes, and the like. Since vertex 304 is a rectangular vertex there is only one arc that originates from it that leads to diamond vertex 306. After providing the input parameters, at time t+2, vertex 306 is activated. Vertex 306 represents the type of therapy or treatment regimen selected by the user at vertex 302. Herein, adjuvant therapy is selected. Accordingly, vertex 306 provides different paths illustrating the kind of adjuvant therapy that may be prescribed to the patient, and the user may select any of the chemotherapies represented by vertices 308, 310, 312 and 314, as shown in FIG. 3.

In various embodiments of the invention, upon selection of adjuvant therapy, analytics engine 104 and cost estimation engine 106 respectively compute the probabilities of various outcomes and the corresponding costs related to the entire therapy. First, using the input parameters and information related to case histories and market research stored in databases 108 and 110, analytics engine 104 computes a close cohort corresponding to the given patient and the prescribed treatment protocol and then computes the probability of various output parameters. (During this process, both ARBE 202 and ANNE 204 may be used for computing the probability of these parameters.) Next, cost estimation engine 106 computes the costs depending on the selection of corresponding cost databases selected by the use; indeed, the user can state that these costs should be as charged by a given hospital or can state that these costs should be those provided by the insurance provider of the given patient. Here, from the patient information, cost estimation engine 106 identifies the relevant tests and procedures that have already been completed and computes the corresponding expected cost for the prescribed protocol for a pre-specified number of years. This process is explained by an illustrative example given below.

For example, a patient suffering from colon cancer has the following characteristics: age=60; gender=male; family history=father had colon cancer at age 40; other diseases that the patient may have=heart attack at age 50; ethnicity=Caucasian; screenings if any done in the past=none; grade of the tumor=3; stage III; and the number of lymph nodes affected=1 to 3. Then analytics engine 104 and cost estimation engine 106 at time, t+2, may provide the following information (not shown in the figure):
1. If only the tumor and related lymph nodes were removed (but no other adjoining or “adjuvant” therapy given) then with a 95% confidence level and ±4% margin of error, there is a 48% likelihood of this colon cancer patient being alive for 5 years or more, there is a 20% likelihood of relapse and potential death because of cancer, and there is 32% likelihood of the patient dying because of other causes. Furthermore, the total average, amortized cost (assuming the present cost structure charged by a particular hospital that the user has chosen) for treating this patient for the next five years is expected to be $83,000.
2. If the tumor and related lymph nodes were removed and if the complete dose of Flox-based chemotherapy was given as suggested by the United States National Comprehensive Care Network (NCCN, www.nccn.org) then with 95% confidence level and with ±4% margin of error, there is a 55% likelihood of this cancer colon patient being alive for 5 years or more, there is a 11% likelihood of relapse and potential death because of cancer, and there is 34% likelihood of dying because of other causes. Furthermore, the total average, amortized cost (assuming the current cost structure charged by a particular hospital that the user has chosen) of treating this patient for the next five years is expected to be $158,000.
3. If the tumor and related lymph nodes were removed and if the complete dose of 5FU-based chemotherapy was given as suggested by NCCN (www.nccn.org) then with 95% confidence level and with ±4% margin of error, there is a 52% likelihood of this cancer colon patient being alive for 5 years or more, there is a 15% likelihood of relapse and potential death because of cancer, and there is 32% likelihood of dying because of other causes. Furthermore, the total average and amortized cost (assuming current cost structure inflation) of treating this patient for the next five years is expected to be $107,000.

Herein, the cost until time t is already fixed since this includes costs that have already incurred. The expected cost of the treatment is computed for the future treatment based on the selection of the path made by the user in the state-transition graph. The expected cost is defined to be the average of various weighted costs for each of the paths that are likely to be involved with respect to the close cohort provided by analytics engine 104. For example, if a breast cancer patient opts for lumpectomy (i.e., removal of only the tumor inside the breast and not the entire breast), if the data of the appropriate close cohort shows that 30% of patients in her cohort need to be operated twice and 10% need to be operated thrice, and if the expected costs for all these surgeries are expected to be equal, then the expected cost for the entire lumpectomy would 1.5 times the cost of a single lumpectomy surgery. Of course, this is assuming that the cost of the first surgery and subsequent surgeries are the same, but if they are not the same then cost estimation engine will use the cost of the individual surgeries and then compute the weighted average.

In an embodiment of the invention, the expected cost is computed based on the current costs of various tests, procedures, surgeries, etc. In another embodiment of the invention, inflation can be incorporated by multiplying the current costs by specific rate of inflation.

In various embodiments of the invention the user may decide to provide a custom or experimental treatment that is not listed as one of the treatment protocols in system 100 and its databases. The ‘other’ button (in GUI) allows the user to do so. As a part of creating this customized protocol, the user can connect the current vertex to any other vertex in the state-transition graph, and that vertex to any other vertex in the graph, and so on. This flexibility is particularly useful for treatment protocols that are in the experimental stage (and for protocols that are undergoing clinical trials).

In various embodiments of the invention, vertex 306, vertex 308, vertex 310, vertex 312, and vertex 314 enable the user to perform a ‘what if’ scenario based analysis. The user clicks on the ‘what if’ button in GUI 102 to explore different scenarios. For example, the user may directly click on vertex 308 to select a path he/she would like to take while treating the patient. Accordingly, vertex 308 is activated at time t+4. The user may then click on the path originating from vertex 308 to reach another vertex at time t+5, and so on. Thus, the user may select the entire treatment regimen for colon cancer while the current state of the patient still corresponds to time t+1 or t+2. After the user has selected the entire path, analytics engine 104 and cost estimation engine 106 compute the output parameters with probabilities (related to statistical significance) and the cost associated with the treatment regimen (by first computing the appropriate close cohort).

In an embodiment of the invention, in addition to ‘other’ and ‘what if’ buttons, GUI 102 also provides a ‘complications’ button for each vertex (not shown in the figure). This button corresponds to the possibility of the patient developing complications (e.g., some cancers such as Hodgkin's disease can give rise to other cancers), occurrence of unexpected events (e.g., the cancer patient has a heart attack while he/she is being treated), and situations that may require crisis management. At any time, t, if a user clicks on the “complications” button, he/she is provided another window in the drop-down menu corresponding to the same vertex. At this step, the user can input various complications and unexpected events that may have occurred, and like the previous case, the user can create his/her own protocol and store that protocol in system 100.

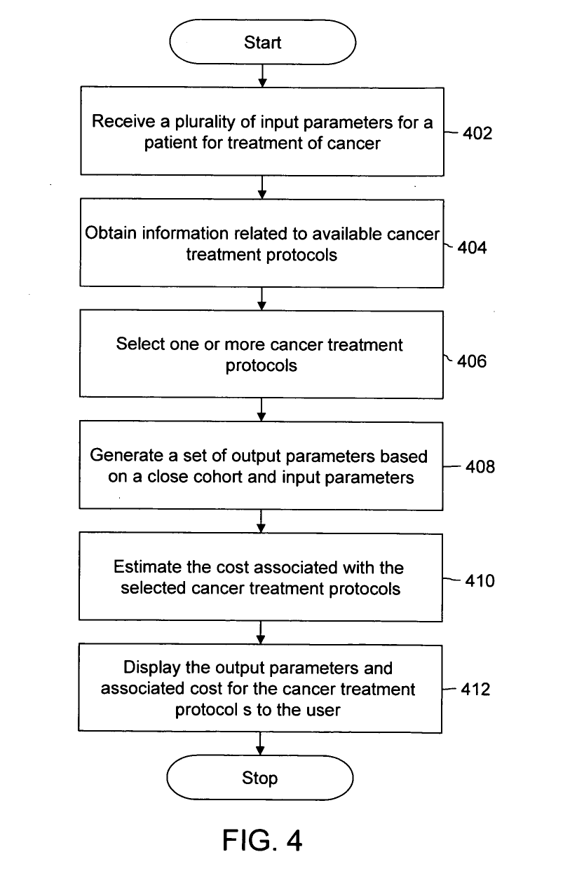

FIG. 4 is a flowchart illustrating a method for performing cost-benefit analysis for treatment of a cancer in accordance with an embodiment of the invention. The method is explained in the context of FIG. 1, FIG. 2, and FIG. 3.

At 402, a plurality of input parameters from a user of system 100 is received. The plurality of input parameters are related to historical information of the patient and to one or more cancer treatment protocols. At 404, information corresponding to each protocol from a set of cancer treatment protocols available to the cancer patient is obtained; this information is stored in the underlying state-transition graph that analytics engine 104 and databases 108 and 110 have. Thereafter, at 406, the user selects one or more cancer treatment protocols from the set of cancer treatment protocols available to the cancer patient. At 408, based on the plurality of input parameters and the selected protocol, a close cohort corresponding to each of the (one or more) cancer treatment protocols is generated and then a set of output parameters (along with their statistical significance) for each protocol is generated. As described earlier, a close cohort (as well as its corresponding output parameters with relevant probabilities) is computed based on the case histories of patients, retrospective data, market research information, and the input parameters as well as the selected protocol for the given patient. Thereafter, at 410, a cost corresponding to each of the one or more cancer treatment protocols is estimated (using the close cohort that was computed at 408). This cost includes the average and amortized cost of performing all tests, procedures, consultations, and surgeries, etc. as per the selected treatment protocols. At 412, the set of output parameters and corresponding costs for the cancer treatment protocols are displayed to the user through GUI 102. The cancer treatment protocols and different options are displayed to the user in the form of a state-transition graph. This has been described in detail in conjunction with FIG. 3.

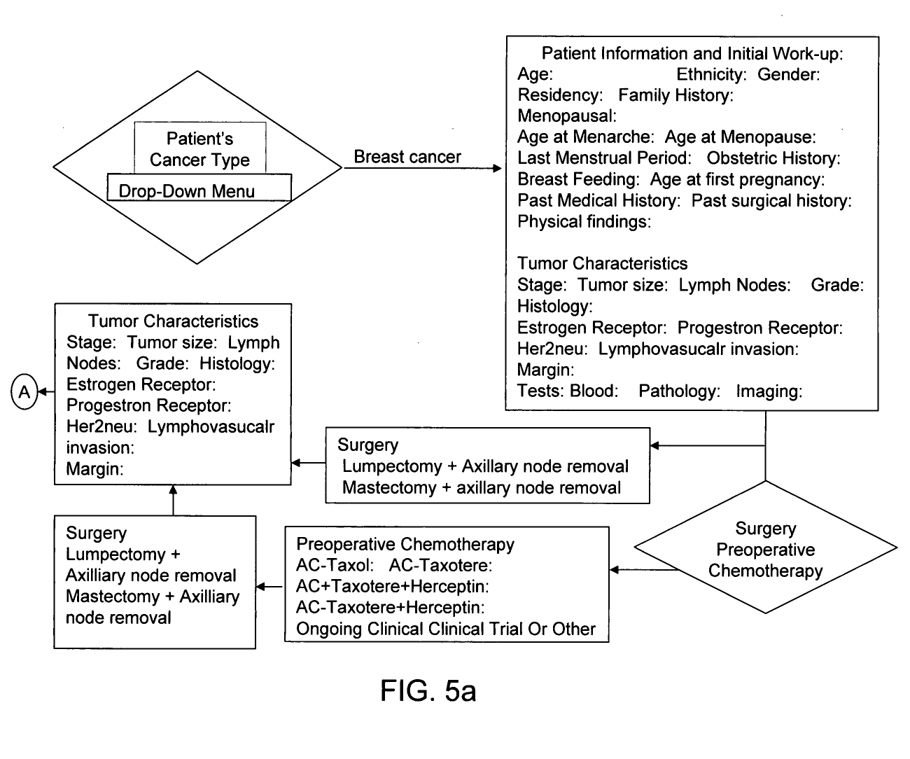

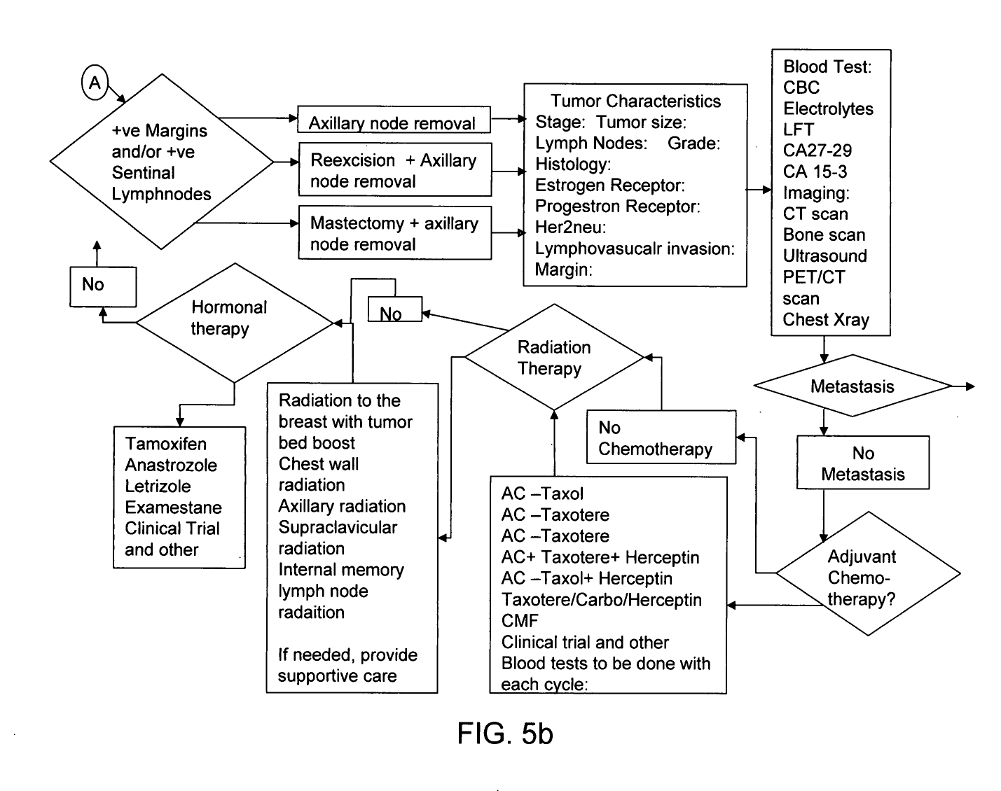

The above-mentioned method and system is further explained for treatment of breast cancer in conjunction with FIGS. 5a and 5b. FIG. 5a and FIG. 5b illustrate a state-transition graph for treatment of breast cancer in light of a set of input variables. A user may select different options provided in the state-transition graph, and accordingly, the potential outcome and corresponding costs are computed at each instance of time. Based on this, the user may perform a cost-benefit analysis. The description of deterministic variables associated with the breast cancer treatment and various lab tests, pathological tests, imaging tests, surgical procedures, therapeutic treatments, supportive therapy, medical consultation, check-up, hospitalization, etc. are also given below. In particular, there are nine sets of input variables that are given below:

### 1. Input Variables—Patient Characteristics:

Sex
Age: (Pre menopausal, Post Menopausal)
Ethnicity
Location or geographical region where the patient resides
Family history with respect to cancer or other chronic diseases
Co morbidity factors: (Perfect health, Minor health problems, Major health problems+, Major health problems++?, Major health problems+++?)
Performance status (as defined by Eastern Cooperative Oncology Group, ECOG):
   PS 0: Fully active, able to carry on all pre-disease performance without restriction
   PS 1: Restricted in physically strenuous activity but ambulatory and able to carry out work of a light or sedentary nature, e.g., light house work, office work
   PS 2: Ambulatory and capable of all self-care but unable to carry out any work activities. Up and about more than 50% of waking hours
   PS 3: Capable of only limited self care, confined to bed or chair more than 50% of waking hours
   PS 4: Completely disabled. Cannot carry on any self-care. Totally confined to bed or chair
   PS 5: Dead

### 2. Input Variables—Tumor Characteristics

Tumor size: (T1a) 0-0.5 cm; (T1b) 0.6-1.0 cm; (T1c) 1.1-2.0 cm; (T2) 2.1-5.0 cm; or (T3) greater than 5.0 cm (T4) tumor of any size extending to skin and/or chest wall
Number of positive lymph nodes: (N0) 0; (N1) 1-3 lymph nodes; (N2) 4-9 lymph nodes with or with out extra-capsular extension; or (N3) more than 9 lymph nodes and/or involvement of infra-clavicular lymph nodes and/or clinically apparent internal mammary lymph nodes
Estrogen receptor: Positive or negative
Progesterone Receptor: Positive or negative
Her 2 neu: Positive or negative
Grade: I, II, or III
Angio-lymphatic invasion: present or absent
Metastasis: If present, where: bone, skin, lungs, liver, brain, and/or other locations
Stages of breast cancer: I, IIa, IIb, IIIa, IIIb, IIIc, and IV
Oncotype Dx Assay (Gene expression profile to assess the need for chemotherapy. Not very widely used currently but is likely to be used in future.)
Other potential parameters (e.g., other genetic markers)
   3. Variables Introduced During Treatment—Surgery (for stage I, II, III):
Lumpectomy with or without Sentinel Lymph node biopsy (complete surgical removal of cancer from breast and some amount of normal breast tissue around it and sampling of lymph node from underarm for testing)
Re-excision (removal of some more breast tissue if the tumor was present at the margin or too close to margin of resection in the earlier lumpectomy)
Axillary Lymph Node dissection (removal of lymph nodes from under arm if the cancer was found in the sentinel Lymph node)
Simple Mastectomy (removal of entire breast not including the chest wall mussels and axillary Lymph nodes)
Modified radical Mastectomy (removal of entire breast up to the chest wall muscle and removal of axillary Lymph nodes

### 4. Variables Introduced During Treatment—Adjuvant Chemotherapy:

CMF (Cyclophosphamide,(generic) Methotrexate(generic) 5FU(generic)); 6 doses every 3 weeks
AC (Adriamycin or Doxorubicin (generic, Pharmacia), cyclophosphamide (generic)); 4 doses every 3 weeks
AC-H (AC is same as above followed by Herceptin every 3 weeks for one year)
AC-T (Adriamycin or Doxorubicin (generic), Cyclophosphamide (generic); 4 doses every 2-3 weeks followed by Taxol or Paclitaxel (Bristol Myers and Squibb, generic); 12 doses every week or 4 doses every 2-3 weeks)
AC-TH (AC—T is same as above. Herceptin (transtuzumab made by Genetech) is given along with taxol and continue every week or every 3 weeks for one year)
CT (Cyclophosphamide (generic), Taxotere or Docetaxel (Sanofi-Aventis) 4 doses Every 3 weeks
CT+H (CT is same but given with Herceptin (trastuzumab (genentech)) Herceptin continues every 3 weeks for one year
TCH (Taxotere or Docetaxel (Sinofi-Aventis), Carboplatin (Generic), Herceptin (see above)) 6 doses every 3 weeks. Herceptin continues every 3 weeks for one year
FEC-T (5FU (generic) Epirubicin (Ellence, by Pfizer) Cyclophophamide ) 3 to 4 doses every 3 weeks followed by Taxotere (Docetaxel) every 3 weeks 3-4 doses
FEC-TH (FEC+T is same as above. Herceptin is given along with Docetaxel every 3 weeks and continues for one year
Other combinations
   5. Variables Introduced During Treatment—Adjuvant Hormonal therapy
Tamoxifen (generic)
Arimidex (Anastrozole By AstraZeneca)
Femara (Letrozole by Novartis)
Aromasin (exemestane By Pfizer)
Experimental or clinical trials

### 6. Variables Introduced During Treatment—Adjuvant Radiation Therapy:

After Lumpectomy radiation is given to whole breast with a boost to the tumor bed and Axillary with or with out radiation to supraclavicular (neck) region
Chest wall radiation after Mastectomy with or without axilliary and supraclavicular region

### 7. Variables Introduced During Treatment of Metastatic Disease: (Stage IV) Hormonal Therapy:

Tamoxifen
Ovarian suppression: Leuprolide injection (Lupron, Abbott), Goserlin injection (Zoladex, Astra Zeneca) Ooferectomy (surgical removal of ovaries)
Aromatase inhibitors: Anastrozole, Letrozole, Examestane
Fulveatrant (Faslodex, AstraZeneca)
Experimental or Clinical trial

### 8. Variables Introduced During Treatment of Bone Metastasis

Zoledronic Acid (Zometa, Novartis)
Pamidronate (Aredia, Novartis)
Newer or experimental drugs

### 9. Palliative Chemotherapy for Stage IV Cancer

Paclitaxel (Taxol, generic, BMS)
Docetaxel (Taxotere, Sanofi-Aventis)
Capecitabine (Xeloda, Roche)
Gemcitabine (Gemzar, Lilly)
Vinorelabine (Navelbine, GSK, generic)
Pegylated liposomal Doxorubicin (Doxil, Ortho-Biotech)
Ixabepilone (Ixempra, BMS)
Albumin bound paclitaxel (Abraxane, Abraxis)
Bevacizumab (Avastin, Genentech) with Chemotherapy
Transtuzumab (Herceptin, Genentech) alone or in combination with chemotherapy
Lopatinib (Tykerb, GSK) alone or in combination with chemotherapy
Carboplatinum (BMS, generic)
Cisplatinum (Generic)
Etoposide (Generic)
Epirubicin (Ellence, Pfizer)
FEC (5FU, Epirubicin, Cyclophosphamide)
CMF (Cyclophosphamide, Methtrexate, 5 FU)
AC (Adriamycin, Cyclophosphamide)
GT (Gemcitabine, Taxol)
Docetaxel/Capecitabine
Ixabepilone/Capecitabine
Newer combinations of above drugs (or experimental drugs)

Some ancillary tests and treatments that are provided while following the NCCN (www.nccn.org) protocol for breast cancer are given below. Although, usually, analytics engine 104 does not need these tests and treatments explicitly (since they do not affect the six output variables), these are required by cost estimation engine 106 for computing the total cost of the treatment.

Palliative Radiation and/or Surgery
For spinal compression
For pain control
For impending fracture
For chest wall or skin metastasis

### Pain Control

Non Steroidal anti inflammatory agents: Ibuprofen, Acetaminophen, Diclofinec etc
Codeine alone or in combination with Acetanimophen
Oxycodone
Long lasting Oxycodone (Oxycontin, Purdue Pharmaceuticals)
Morphine Sulfate
Long Lasting Morphine sulfate (MSContin, Purdue pharmaceuticals)
Fentanyl patch (duragesic, orthoMcNeil)
Fentanyl buccal preparation (Actiq, Cephlon)
Methadone (Generic)
Steroids (Dexamethsone)
Other (e.g., experimental) drugs

### Providing Anti-Nausea Medicines

5 HT3 receptor antagonists: Zofran (Odansetron By GSK and generic), Kytril (Granisetron by Roche), Aloxi (Palonosetron by Eisai), Anzemet (dolesetron by Sanofi-Aventis)
Phenbthiazines: Compazine(prochlorperazine (generic)), Regaln (metachlopropamide (generic).
NK 1 Recepter antagonists: Emend (Aprepitant by Merk),
Ativan (Lorazepam (Generic)
Steroids: Dexamethasone (generic)
Other (e.g., experimental) medications

### Providing Growth Factors:

Neupogen (filgrastim by Amgen)
Neulasta (pegifilgrastim by Amgen)
Other (e.g., experimental) growth factors

### Staging Work Up:

Blood count, Electrolytes, Liver function test, Tumor markers
Chest X ray
Computerized Tomography(CT) scan of chest abdomen and pelvis
Bonescan
Positron Emission Tomography (PET)/CT scan ±
Magnetic Resonance Imaging (MRI) of breast
Mammogram
Ultrasound of breast
Echo-cardiogram
Core Biopsy or fine needle biopsy (remove a piece of tumor with thick needle for testing)
Excisional Biopsy (surgically remove tumor for testing)

### Providing Antacids:

H2 blockers (e.g. Fomatidine, Ranitidine)
Proton Pump Inhibitors (e.g. Omeprazole, Esomeprazole, pantoprazole, Lansoprazole)

### Providing Intravenous Access:

Patient may require intravenous access for chemotherapy such as Mediport (which is a surgically Implanted device under the skin that is connected to one of the large vein via a tunneled catheter) or a PICC line (which is a long lasting catheter that goes into a large vein)

### Follow Up During Hormonal Therapy and Beyond:

Doctor's visit every 3-6 months with history and physical exam
Blood work: CBC, Liver function test, Kidney function test, Tumor markers
Mammogram: 6 moths after radiation. Once stability is established, Mammogram every year
Gynecological exam every year while on tamoxifen
Bone Density every year while on Aromatase inhibitor. If Osteopenia or Osteoporosis is found consider using Intravenous or oral bisphosphonate and calcium
Lipid profile (Cholesterol profile) every 6 months while on aromatase inhibitor
CT scan to be done if abnormality is found on blood work, or if symptoms occur or high risk for recurrence
Bone scans to be done if alkaline phosphatase is elevated or if patient has symptoms of bone pain
Biopsy to be done if an abnormality is found

### Output Variables

1. The overall survival after a pre-defined number of years represents the likelihood of the patient surviving for at least the pre-defined number of years after the treatment versus the likelihood of death within the pre-defined number of years because of the disease or otherwise.
2. The disease free survival for the pre-defined number of years represents the likelihood of the patient surviving without a relapse of the disease for at least the pre-defined number of years after the treatment has been given (i.e., after time t).
3. Tumor response rate represents the likelihood of the patient's tumor responding to a given treatment, therapy or procedure within a defined time period. This defined time period may be different for different therapies or treatments for the same disease such as cancer.
4. Time to progression of symptoms is related to two other output parameters, progression-free survival and disease-free survival, and is quantified as a function of these parameters. However, by providing an appropriate function, the systems administrator may also define this parameter differently (if the system administrator selects to do so).
5. Quality of life (in the long term, i.e., after the treatment) is a subjective parameter but is usually defined as a function that is based upon pain, fatigue, and the performance status of the patient after the treatment.
6. Cost of the entire treatment going forward is the expected cost of the entire treatment including the costs of lab tests, imaging tests, procedures, therapies, hospitalization, consultation etc. Of course, this cost depends upon the costs' database that is used and varies quite a lot if a costs' database provided by a hospital is used versus, for example, that provided by an insurance company.

The system for providing cost-benefit analysis for treatment of a disease, and cancer in particular, as described in the present invention or any of its components, may be embodied in the form of a computer system. Typical examples of a computer system include a general-purpose computer, a programmed microprocessor, a micro-controller, a peripheral integrated circuit element, and other devices or arrangements of devices that are capable of implementing the steps that constitute the method of the present invention.

The computer system comprises a computer, an input device, a display unit, and the Internet. The computer also comprises a microprocessor or processor, which is connected to a communication bus. The computer also includes a memory, which may include Random Access Memory (RAM) and Read Only Memory (ROM). Further, the computer system comprises a storage device, which can be a hard disk drive or a removable storage drive such as a floppy disk drive, an optical disk drive, etc. The storage device can also be other similar means for loading computer programs or other instructions into the computer system. The computer system also includes a communication unit. The communication unit allows the computer to connect to other databases and the Internet through an I/O interface. The communication unit allows the transfer as well as reception of data from many other databases. The communication unit includes a modem, an Ethernet card, or any similar device, which enables the computer system to connect to databases and networks such as LAN, MAN, WAN and the Internet. The computer system facilitates inputs from a user through an input device that is accessible to the system through an I/O interface.

The computer system executes a set of instructions that are stored in one or more storage elements, in order to process the input data. The storage elements may also hold data or other information, as desired, and may be in the form of an information source or a physical memory element in the processing machine.

The set of instructions may include various commands instructing the processing machine to perform specific tasks such as the steps that constitute the method of the present invention. The set of instructions may be in the form of a software program written on any suitable computer readable media. Further, the software may be in the form of a collection of separate programs, a program module with a larger program, or a portion of a program module, as in the present invention. The software may also include modular programming in the form of object-oriented programming. The processing of input data by the processing machine may be in response to a user's commands, the results of previous processing, or a request made by another processing machine. Examples of programming languages may include object-oriented languages such as C++, Java, and the like.

While the preferred embodiments of the invention have been illustrated and described, it will be clear that the invention is not limited to these embodiments only. Numerous modifications, changes, variations, substitutions and equivalents will be apparent to those skilled in the art without departing from the spirit and scope of the invention as described in the claims.

What is claimed is:

1. A system for performing a cost-benefit analysis for one or more cancer treatment protocols for a patient diagnosed with cancer, the system comprising:
a graphical user interface for receiving a plurality of input parameters from a user and/or a system administrator, the plurality of input parameters being related to current and historical information of the cancer patient and to the one or more cancer treatment protocols;
an analytics engine for performing statistical and computational analysis to generate a set of output parameters based on the plurality of input parameters and a close cohort corresponding to each of the one or more cancer treatment protocols, the set of output parameters being related to the outcome of each of the one or more cancer treatment protocols, the close cohort corresponding to the one or more cancer treatment protocols comprising a group of patients being subjected to treatments that are similar to the one or more cancer treatment protocols provided to the patient, exhibit input parameters similar to the plurality of input parameters, and also exhibit substantially similar output parameters; and
a cost estimation engine for estimating the corresponding cost for each of the one or more cancer treatment protocols based on the close cohort,
wherein the set of output parameters and the corresponding cost for each of the one or more cancer treatment protocols are displayed to the user through the graphical user interface.

2. The system according to claim 1 wherein the output parameters comprise at least one of overall survival after a specified number of years, disease-free survival for a specified number of years, progression-free survival for a specified number of years, tumor response rate, time to progression of symptoms, and quality of life.

3. The system according to claim 1 further comprising one or more databases for storing a plurality of cancer treatment protocols available to the cancer patient.

4. The system according to claim 1 wherein the analytics engine is connected to a plurality of databases, the plurality of databases comprising data related to case histories of patients, data related to on-going and past clinical research, and market research information and data.

5. The system according to claim 1 wherein the cost estimation engine is connected to a plurality of cost-related databases, the plurality of cost-related databases comprising data related to costs for cancer treatment protocols and procedures, lab tests, pathology tests, imaging tests, supportive care costs, hospitalization related costs, and costs related to consultations.

6. The system according to claim 1 wherein the input parameters further comprise parameters related to complications arising from the one or more cancer treatment protocols and unexpected events.

7. The system according to claim 1 wherein the analytics engine comprises a rule-based engine, wherein the rule-based engine is used to generate the output parameters.

8. The system according to claim 1 wherein the analytics engine comprises a neural network engine, the neural network engine being used to generate the output parameters when the number of patients in the close cohort is less than a specified number.

9. A method for performing a cost-benefit analysis for one or more cancer treatment protocols for a patient diagnosed with cancer, the method comprising the steps of:
receiving a plurality of input parameters from a user, the plurality of input parameters being related to historical information of the patient and to the one or more cancer treatment protocols;
generating a set of output parameters based on the plurality of input parameters and a close cohort corresponding to each of the one or more cancer treatment protocols, the set of output parameters being related to the outcome of each of the one or more cancer treatment protocols, the close cohort corresponding to the one or more cancer treatment protocols comprising a group of patients being subjected to treatments that are similar to the one or more cancer treatment protocols provided to the patient, exhibit input parameters similar to the plurality of input parameters, and exhibit substantially similar output parameters; and
estimating a cost corresponding to each of the one or more cancer treatment protocols based on the close cohort; and
displaying the set of output parameters and the corresponding cost for each of the one or more cancer treatment protocols.

10. The method according to claim 9 wherein the output parameters comprise at least one of overall survival after a number of years, disease-free survival for a number of years, progression-free survival for a number of years, tumor response rate, time to progression of symptoms and quality of life.

11. The method according to claim 9 wherein the close cohort corresponding to each of the one or more cancer treatment protocols is identified by using data obtained from a plurality of databases, wherein the plurality of databases maintain data related to case histories of patients, data related to on-going and past clinical research, and market research information and data.

12. The method according to claim 9 wherein the corresponding cost for each of the one or more cancer treatment protocols is estimated by using data obtained from a plurality of cost-related databases, wherein the cost-related databases maintain data related to costs for cancer treatment protocols, lab tests, pathology tests, imaging tests, supportive care costs, hospitalization related costs, and costs related to consultations and procedures, lab tests, pathology tests and imaging tests.

13. The method according to claim 9 wherein the input parameters further comprise parameters related to complications arising from the one or more cancer treatment protocols and unexpected events.

14. A system for performing a cost-benefit analysis for one or more cancer treatment protocols for a patient diagnosed with cancer, the system comprising:
a graphical user interface for receiving a plurality of input parameters from a user, the plurality of input parameters being related to historical information of the cancer patient and to the one or more cancer treatment protocols;
an analytics engine for performing the cost benefit analysis for the one or more cancer treatment protocols based on the plurality of input parameters, the analytics engine comprising:
an analytical rule based engine for computing a set of output parameters based on a close cohort corresponding to each of the one or more cancer treatment protocols, the set of output parameters being related to the outcome of each of the one or more cancer treatment protocols, wherein the close cohort corresponding to the one or more cancer treatment protocols comprises a group of patients being subjected to treatments similar to the one or more cancer treatment protocols provided to the patient, exhibit input parameters that are similar to the plurality of input parameters, and exhibit substantially similar output parameters; and
an artificial neural network engine for computing the set of output parameters corresponding to each of the one or more cancer treatment protocols based on at least one transfer function, wherein the artificial neural network engine performs the computation when the number of patients in the close cohort corresponding to each of the one or more cancer treatment protocols is less than a specified number; and
a cost estimation engine for calculating a corresponding cost for each of the one or more cancer treatment protocols based on the close cohort corresponding to each of the one or more cancer treatment protocols, wherein the set of output parameters and the corresponding cost for each of the one or more cancer treatment protocols are displayed to the user through the graphical user interface.

15. The system according to claim 14 wherein the output parameters comprise at least one of overall survival after a specified number of years, disease-free survival for a specified number of years, progression-free survival for a specified number of years, tumor response rate, time to progression of symptoms and quality of life.

16. The system according to claim 14 further comprising one or more databases for storing a plurality of cancer treatment protocols available to the cancer patient.

17. The system according to claim 14 wherein the analytics engine is connected to a plurality of databases, wherein the plurality of databases maintain data related to case histories of patients, data related to on-going and past clinical research, and market research information and data.

18. The system according to claim 14 wherein the cost estimation engine is connected to a plurality of cost-related databases, wherein the cost-related databases maintain data related to costs for cancer treatment protocols, lab tests, pathology tests, imaging tests, supportive care costs, hospitalization related costs, and costs related to consultations.

19. The system according to claim 14 wherein the input parameters further comprise parameters related to complications arising from the one or more cancer treatment protocols and unexpected events.

20. A system for performing a cost-benefit analysis for one or more treatment protocols for a patient diagnosed with a disease, the system comprising:
a graphical user interface for receiving a plurality of input parameters from a user, the plurality of input parameters being related to historical information of the patient and to the one or more treatment protocols;
an analytics engine for generating a set of output parameters based on the plurality of input parameters and a close cohort corresponding to each of the one or more treatment protocols, the set of output parameters being related to the outcome of each of the one or more treatment protocols, the close cohort corresponding to the one or more cancer treatment protocols comprising a group of patients being subjected to treatments that are similar to the one or more cancer treatment protocols provided to the patient, exhibit input parameters similar to the plurality of input parameters, and exhibit substantially similar output parameters; and
a cost estimation engine for estimating the corresponding cost for each of the one or more treatment protocols based on the close cohort, wherein the set of output parameters and the corresponding cost for each of the one or more treatment protocols are displayed to the user through the graphical user interface.

21. The system according to claim 20 wherein the disease is cancer.

22. A computer program product for use with a computer, the computer program product comprising a computer usable medium having a computer readable program code embodied therein for providing cost-benefit analysis for one or more cancer treatment protocols for a patient diagnosed with cancer, the computer readable program code performing the steps of
receiving a plurality of input parameters from a user and/or a system administrator, the plurality of input parameters being related to historical information of the cancer patient and to the one or more cancer treatment protocols;
performing statistical and computational analysis to generate a set of output parameters based on the plurality of input parameters and a close cohort corresponding to each of the one or more cancer treatment protocols, the set of output parameters being related to the outcome of each of the one or more cancer treatment protocols, the close cohort corresponding to the one or more cancer treatment protocols comprising a group of patients being subjected to treatments that are similar to the one or more cancer treatment protocols provided to the patient, exhibit input parameters similar to the plurality of input parameters, and exhibit substantially similar output parameters; and
estimating the corresponding cost for each of the one or more cancer treatment protocols based on the close cohort; and
displaying the set of output parameters and the corresponding cost for each of the one or more cancer treatment protocols to the user.
